(19) United States
(12) Patent Application Publication
(10) Pub. No.: US 2026/0307580 A1
(43) Pub. Date: Oct. 8, 2026

(54) ACTUATOR AND ACTUATOR ASSEMBLY METHOD

(71) Applicant: KOITO MANUFACTURING CO., LTD., Tokyo (JP)

(72) Inventors: Masatsugu Murayama, Shizuoka (JP); Ko Nozawa, Shizuoka (JP); Naoki Takii, Shizuoka (JP)

(73) Assignee: KOITO MANUFACTURING CO., LTD., Tokyo (JP)

(21) Appl. No.: 19/481,432

(22) PCT Filed: May 8, 2024
(86) PCT No.: PCT/JP2024/017047

§ 371 Date: Nov. 4, 2025

(30) Foreign Application Priority Data
May 9, 2023 (JP) 2023077509
May 9, 2023 (JP) 2023077510
May 9, 2023 (JP) 2023077511
May 9, 2023 (JP) 2023077512
May 9, 2023 (JP) 2023077513

(51) Int. Cl. B60Q 1/068; B60Q 1/076

(52) U.S. Cl. CPC B60Q 1/068; B60Q 1/076; B60Q 2200/30

(57) ABSTRACT

An actuator for changing an irradiation direction of a vehicle lamp. The actuator includes a rotating member configured to rotate as a motor rotates, a rod including a connection portion connected to a mechanism configured to tilt an optical member provided in the vehicle lamp, the rod being coaxially coupled to the rotating member in a relatively rotatable manner, a housing configured to accommodate the rotating member and the rod; a locking portion configured to lock, at a predetermined position of the housing, a rear end portion of the rotating member, the rear side being on a opposite side to a side to which the rod is coupled, and a displacement restraining portion provided between the rear end portion of the rotating member and the housing, the displacement restraining portion being configured to restrain displacement of the rear end portion.

### TECHNICAL FIELD

The present disclosure relates to an actuator and an actuator assembly method.

### BACKGROUND ART

In related art, there has been known a leveling actuator device that changes an irradiation direction by adjusting an optical axis of a vehicle headlamp according to an inclination angle of a vehicle. For example, Patent Literature 1 discloses an illumination corrector that includes an electric motor, a rod that is rotated by the electric motor, and a mechatronics device that partially covers a periphery of the rod and converts rotational motion of the rod into linear motion. A tip end of the rod is provided with a spherical portion, and when the spherical portion fitted into a connection portion on a back surface of a reflector advances or retracts, the reflector tilts, and thus the irradiation direction of the illuminator changes.

### CITATION LIST

### Patent Literature

Patent Literature 1: JP2009-26763A

### SUMMARY OF INVENTION

### Technical Problem

When assembling the vehicle headlamp, the illumination corrector described above requires that the spherical portion at the tip end of the rod be fitted into a capsule on the back surface of the reflector. In this case, if an excessive load is applied to the spherical portion at the tip end of the rod, there is a risk that when a rear end of the rod abuts against another component such as a housing, the component may be deformed.

The present disclosure has been made in view of such circumstances, and an object of the present disclosure is to provide a new technique for reducing damage to components that form an actuator when the actuator is assembled to another unit.

Further, the illumination corrector described above requires that an electrical module be mounted on a rear cap of the housing and that the mechatronics device and the rod be attached to a front cap, leaving room for improvement in terms of ease of assembly.

The present disclosure has been made in view of such circumstances, and an object of the present disclosure is to provide a new actuator assembly method that is relatively easy to assemble.

Further, an idea for a configuration for advancing and retracting the rod described above is to couple the rotating member that is rotated by a motor and the rod that advances and retracts as the rotating member rotates by meshing between the rotating member and the rod with threads. In this case, a female thread is provided on one component, and a female thread is provided on the other component. In the case of producing a component with a mold, rotational punching is required for the component on which the female thread is to be formed. Therefore, depending on the shape and size of the component on which the female thread is to be formed, it may be difficult to form the female thread.

The present disclosure has been made in view of such circumstances, and an object of the present disclosure is to provide a new configuration for threaded parts that couple the rotating member and the rod that advances and retracts.

In the illumination corrector described above, a plurality of components are accommodated in the housing formed by the front cap and the rear cap, and proper arrangement and positioning of each component is required.

The present disclosure has been made in view of such circumstances, and an object of the present disclosure is to provide a new configuration that is effective for arrangement and positioning of components included in an actuator.

Further, in the illumination corrector described above, the plurality of components are accommodated in the housing formed by the front cap and the rear cap, and proper arrangement of the components is required.

The present disclosure has been made in view of such circumstances, and an object of the present disclosure is to provide an actuator having a new configuration by devising the arrangement of the components included in the actuator.

### Solution to Problem

In order to solve the above problem, an actuator according to an aspect of the present disclosure is an actuator used for changing an irradiation direction of a vehicle lamp, the actuator including: a rotating member configured to rotate in conjunction with rotation of a motor; a rod having a connection portion connected to a mechanism that tilts an optical member provided in the vehicle lamp, and coaxially coupled to the rotating member in a relatively rotatable manner; a housing configured to accommodate the rotating member and the rod; a locking portion that locks, at a predetermined position of the housing, a rear end portion of the rotating member on a side opposite to a side to which the rod is coupled; and a displacement restraining portion provided between the rear end portion of the rotating member and the housing, and configured to restrain displacement of the rear end portion. The displacement restraining portion is a flat surface that is provided on an inner wall of the housing and against which the rear end portion of the rotating member abuts. The flat surface is larger in area than an end surface of the rear end portion.

According to this aspect, deformation of the locking portion is limited by restraining displacement of the rear end portion of the rotating member. In addition, since the flat surface has a larger area than the end surface of the rear end portion, the entire end surface can abut against the flat surface, and the stress of a portion where the rear end portion of the rotating member abuts against the flat surface can be distributed.

An actuator assembly method according to an aspect of the present disclosure is an actuator assembly method used for changing an irradiation direction of a vehicle lamp, the actuator assembly method including: a step of preparing a housing in which a first opening and a second opening are provided on different side surfaces; a step of placing a rotating member, which rotates in conjunction with rotation of a motor, at a predetermined position of the housing through the first opening; a step of inserting a rod, which is connected to a mechanism that tilts an optical member provided in the vehicle lamp, through the second opening, and coupling the rod coaxially with the rotating member; and a step of mounting a holding member, which holds the rod, to the second opening. The holding member includes a positioning portion that determines a position where the rod protrudes most through the second opening by the rod abutting against the positioning portion, and an engaging portion for engagement such that the holding member does not come off from the second opening in a state of being mounted to the second opening.

According to this aspect, since the plurality of components to be coupled to each other can be inserted through different openings and then coupled coaxially, the degree of freedom in the assembly process is increased, and the assembly becomes easy. Further, the holding member is configured such that the position at which the rod protrudes most is determined, and the holding member does not come off from the second opening.

An actuator according to an aspect of the present disclosure is an actuator used for changing an irradiation direction of a vehicle lamp, the actuator including: a rotating member configured to rotate in conjunction with rotation of a motor; a rod having a connection portion connected to a mechanism that tilts an optical member provided in the vehicle lamp, and coaxially coupled to the rotating member in a relatively rotatable manner; a housing formed with an opening through which the rod advances and retracts; and a holding member to be mounted to the opening and configured to hold the rod slidably in an advancing-retracting direction while preventing rattling of the rod in a direction intersecting the advancing-retracting direction. The rod has a female thread formed in a hole formed from an end portion on a side coupled to the rotating member toward the connection portion. The rotating member has a male thread provided on an outer periphery of an end portion on a side coupled to the rod. The male thread and the female thread mesh with each other to couple the rotating member and the rod.

According to this aspect, the rotating member and the rod can be rotatably coupled to each other by simple processing. Further, since the male thread is provided on the outer periphery of the rotating member, processing and manufacturing for forming the thread are relatively easy.

An actuator according to an aspect of the present disclosure is an actuator used for changing an irradiation direction of a vehicle lamp, the actuator including: a rotating member configured to rotate in conjunction with rotation of a motor; a rod having a connection portion connected to a mechanism that tilts an optical member provided in the vehicle lamp, and coaxially coupled to the rotating member in a relatively rotatable manner; and a first housing formed with an opening through which the rod advances and retracts.

According to this aspect, the rotating member and the rod can be disposed in the first housing.

An actuator according to an aspect of the present disclosure is an actuator used for changing an irradiation direction of a vehicle lamp, the actuator including: a rotating member configured to rotate in conjunction with rotation of a motor; a rod having a connection portion connected to a mechanism that tilts an optical member provided in the vehicle lamp, and coaxially coupled to the rotating member in a relatively rotatable manner; a housing formed with a first opening through which the rod advances and retracts; a board on which an electronic component configured to control the rotation of the motor is mounted; and a connector to be mounted on the board and connected to a cable for transmitting a signal to the electronic component from outside. The connector is disposed in a direction the same as the first opening.

According to this aspect, the rod and the connector can be arranged in the same direction with respect to the housing.

Any combination of the above components, and a conversion of the expressions of the present disclosure into a manufacturing method, a device such as a lamp or lighting device, a light-emitting module, a light source, and the like are also valid aspects of the present disclosure.

### Advantageous Effects Of Invention

According to an aspect of the present disclosure, damage to components that form the actuator can be reduced.

According to an aspect of the present disclosure, it is possible to achieve a new actuator assembly method that is relatively easy to assemble.

According to an aspect of the present disclosure, it is possible to achieve a new configuration for threaded parts that couple the rotating member and the rod that advances and retracts.

According to an aspect of the present disclosure, it is possible to provide a new technique that is effective for arrangement and positioning of components included in the actuator.

### BRIEF DESCRIPTION OF DRAWINGS

FIG. 1 is a cross-sectional view illustrating an example of a vehicle lamp including an actuator according to the present embodiment.

FIG. 2 is a cross-sectional view of the vehicle lamp illustrated in FIG. 1 when viewed from a front direction.

FIG. 3 is an overall perspective view of the actuator according to the present embodiment.

FIG. 4 is an exploded perspective view of the actuator according to the present embodiment.

FIG. 5 is a partial side view illustrating a main part of a speed reduction mechanism in the actuator according to the present embodiment.

FIG. 6 is a perspective view of a rotating member according to the present embodiment.

FIG. 7 is a side view of the rotating member according to the present embodiment.

FIG. 8 is a perspective view of a rod according to the present embodiment. FIG. 9 is a view of the rod illustrated in FIG. 8 as viewed from a direction A.

FIG. 10 is a view of the rod illustrated in FIG. 8 as viewed from a direction B.

FIG. 11 is a view of the rod illustrated in FIG. 8 as viewed from a direction C.

FIG. 12 is a perspective view of a holding member according to the present embodiment.

FIG. 13 is a view of the rod illustrated in FIG. 12 as viewed from a direction D.

FIG. 14 is a view of the rod illustrated in FIG. 12 as viewed from a direction E.

FIG. 15 is a view of the rod illustrated in FIG. 12 as viewed from a direction F.

FIG. 16 is a G-G cross-sectional view of the actuator illustrated in FIG. 3.

FIG. 17 is a view illustrating a state in which the rod is extended further than a state illustrated in FIG. 16.

FIG. 18 is a front view of a displacement restraining portion viewed from a rear end portion of the rotating member.

FIG. 19 is a perspective view of a rod according to a modification.

FIG. 20 is a cross-sectional view including a rotation shaft of a spur gear and a rotation shaft of a motor included in the actuator according to the present embodiment.

FIG. 21 is a side view illustrating an example of the actuator according to the present embodiment.

FIG. 22 is a J-J cross-sectional view of the actuator illustrated in FIG. 21.

FIG. 23 is a view of a control board mounted on a back surface side of a housing as viewed from a cover side.

FIG. 24 is a partial cross-sectional view of the actuator according to the present embodiment as viewed from an opening side through which the rod advances and retracts.

### DESCRIPTION OF EMBODIMENTS

Hereinafter, the present disclosure will be described based on a preferred embodiment with reference to the drawings. The same or equivalent components, members, and processes shown in the drawings are denoted by the same reference numerals, and redundant descriptions thereof will be omitted as appropriate. The embodiment is illustrative rather than limiting the invention, and not all features and combinations thereof described in the embodiment are necessarily essential to the invention.

### Vehicle Lamp

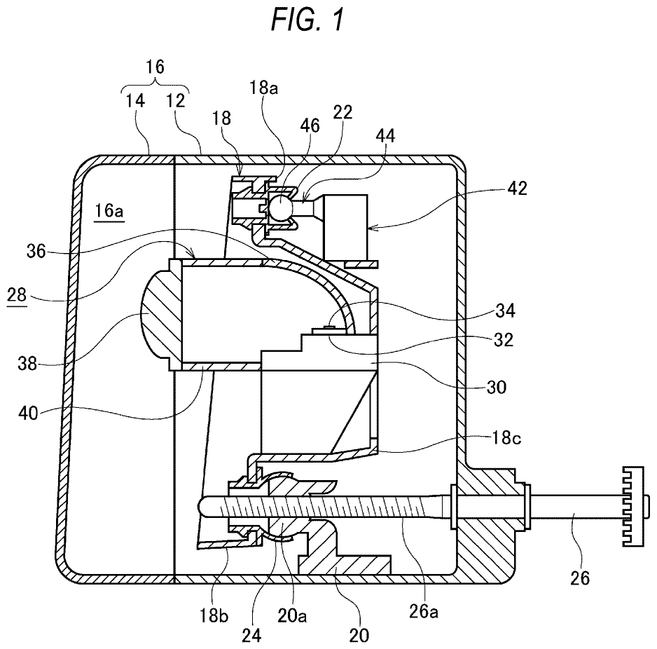

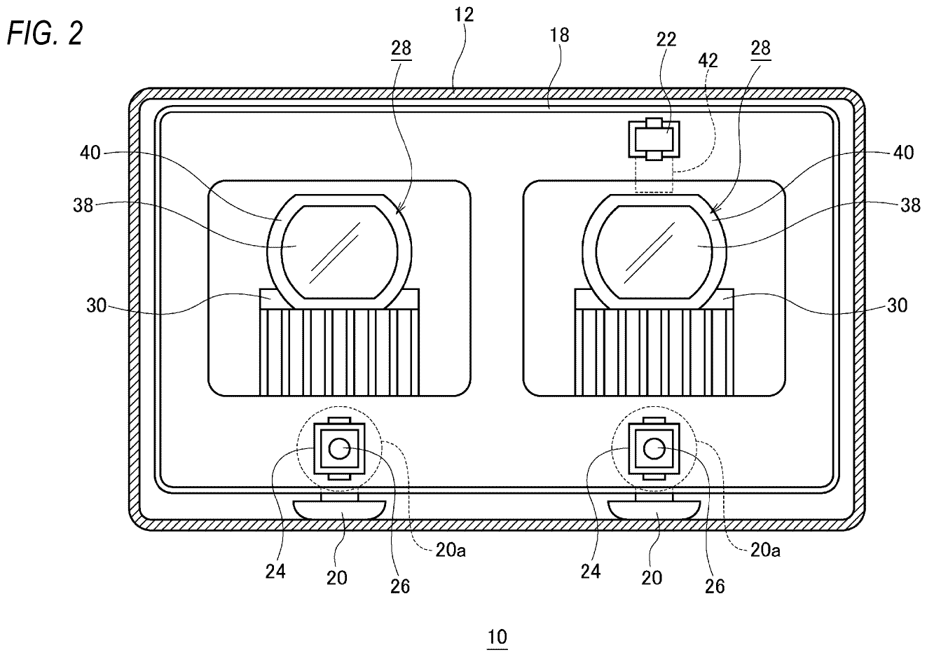

FIG. 1 is a cross-sectional view illustrating an example of a vehicle lamp including an actuator according to the present embodiment. FIG. 2 is a cross-sectional view of the vehicle lamp 10 illustrated in FIG. 1 when viewed from a front direction. The vehicle lamp 10 illustrated in FIG. 1 shows one of left and right headlamps. The headlamps are attached to both sides of a vehicle front portion in a vehicle width direction, and an area ahead of the vehicle is illuminated by the pair of headlamps.

The vehicle lamp 10 includes a lamp housing 12 that has an opening on a front side, and a cover 14 that closes the opening of the lamp housing 12. The lamp housing 12 and the cover 14 form a lamp outer casing 16, and the inside of the lamp outer casing 16 is formed as a lamp chamber 16a.

A frame 18 is disposed in the lamp chamber 16a. The frame 18 includes an upper support portion 18a provided at an upper end portion, a pair of lower support portions 18b provided at a lower end portion, and a unit attachment portion 18c provided at an intermediate portion. The pair of lower support portions 18b are disposed apart from each other in a left-right direction of the vehicle.

Screw support members 20 are provided on rear sides of the lower support portions 18b in the frame 18. An upper front end portion of the screw support member 20 is provided as a spherical portion 20a. The screw support member 20 is supported by the lamp housing 12 so as to be movable in a front-rear direction of the vehicle body.

Bearing members 22 and 24 are respectively attached to the upper support portion 18a and the lower support portion 18b of the frame 18 in a penetrating state.

The spherical portions 20a of the screw support members 20 are coupled to the bearing members 24, respectively. The bearing member 24 is rotatable in any direction with respect to the screw support member 20.

A pair of aiming screws 26 are supported by the lamp housing 12 so as to be rotatable but immovable in the front-rear direction (axial direction). The aiming screws 26 are disposed apart from each other in the left-right direction of the vehicle, and rear end portions thereof protrude rearward from the lamp housing 12. The aiming screw 26 has a threaded portion 26a, and the threaded portion 26a is coupled to the screw support member 20.

A lamp unit 28 is attached to the unit attachment portion 18c of the frame 18. The number of lamp units 28 attached to the unit attachment portion 18c may be one, or three or more.

The lamp unit 28 includes a heat sink 30 configured to dissipate heat, a substrate 32 disposed on the heat sink 30, a light source 34 mounted on the substrate 32, a reflector 36 that reflects light emitted from the light source 34 forward, a projection lens 38 through which the light emitted from the light source 34 passes, and a holder 40 that holds the projection lens 38.

An actuator 42 is disposed in the lamp chamber 16a. For example, the actuator 42 is disposed on the rear side of the lamp unit 28 in an upper portion of the lamp chamber 16a, and is fixed to a part of the lamp housing 12.

### Optical Axis Adjustment in Vehicle Lamp

Next, optical axis adjustment in the vehicle lamp 10 will be described. The vehicle lamp 10 is configured to allow aiming adjustment, which is an initial adjustment of an irradiation direction, and leveling adjustment, which adjusts deviation of an optical axis that changes depending on the weight of an object mounted on the vehicle. There are two types of aiming adjustments: left-right aiming adjustment and upper-lower aiming adjustment.

The left-right aiming adjustment is performed by rotating one of the aiming screws 26. When the aiming screw 26 is rotated, the screw support member 20 to which the threaded portion 26a is screwed is sent forward or rearward according to a rotation direction of the aiming screw 26, and the frame 18 and the lamp unit 28 are integrally rotated about a fulcrum axis that is a line connecting the spherical portion 20a of the other screw support member 20 and a spherical portion 46 at a tip end of a rod 44. By rotating the frame 18 and the lamp unit 28 together, the direction of the optical axis in the lamp unit 28 is displaced left and right, and the left-right aiming adjustment is performed.

The upper-lower aiming adjustment is performed by rotating both the aiming screws 26 in the same direction. When the aiming screw 26 is rotated, the screw support member 20 to which the threaded portion 26a is screwed is sent forward or rearward according to a rotation direction of the aiming screw 26, and the frame 18 and the lamp unit 28 are integrally rotated about the spherical portion 46 of the rod 44 as a fulcrum. By rotating the frame 18 and the lamp unit 28 together, the direction of the optical axis in the lamp unit 28 is displaced up and down, and the upper-lower aiming adjustment is performed.

The leveling adjustment is performed by operating a drive mechanism of the actuator 42. When the drive mechanism is operated, the rod 44 moves in the front-rear direction of the vehicle with respect to the lamp housing 12.

For example, when the rod 44 is moved forward, the bearing members 22 and 24 are rotated with respect to the spherical portion 46 and the spherical portion 20a, respectively, and as the bearing members 22 and 24 rotate, the frame 18 and the lamp unit 28 are integrally rotated downward with a line connecting the spherical portion 20a as a fulcrum axis. By rotating the frame 18 and the lamp unit 28 together, the direction of the optical axis in the lamp unit 28 is displaced downward, and the leveling adjustment is performed.

On the other hand, for example, when the rod 44 is moved rearward, the bearing members 22 and 24 are rotated with respect to the spherical portion 46 and the spherical portion 20a, respectively, and as the bearing members 22 and 24 rotate, the frame 18 and the lamp unit 28 are integrally rotated upward with the line connecting the spherical portion 20a as the fulcrum axis. By rotating the frame 18 and the lamp unit 28 together, the direction of the optical axis in the lamp unit 28 is displaced upward, and the leveling adjustment is performed.

### Actuator

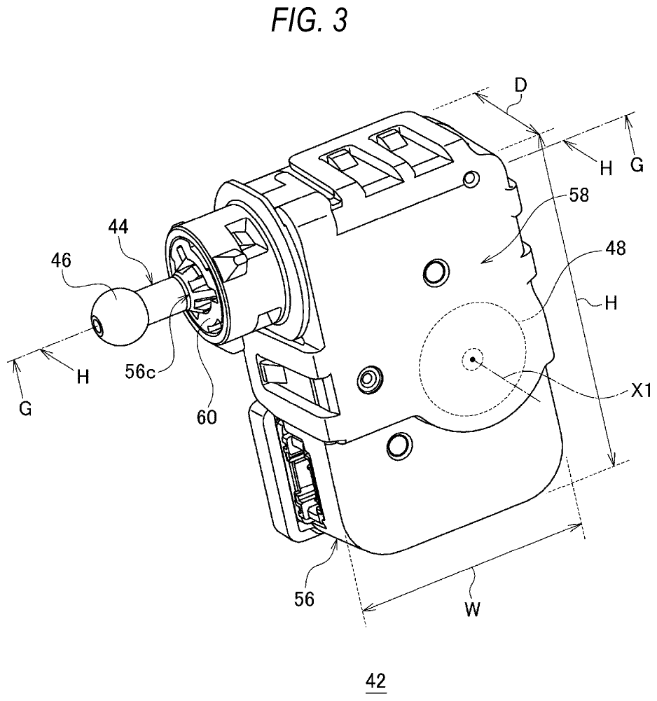

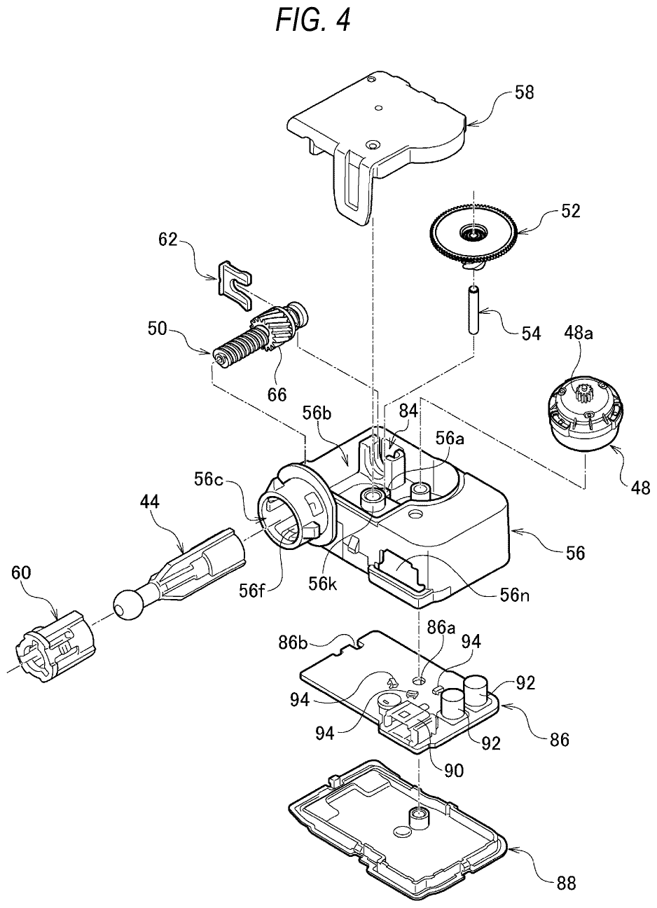

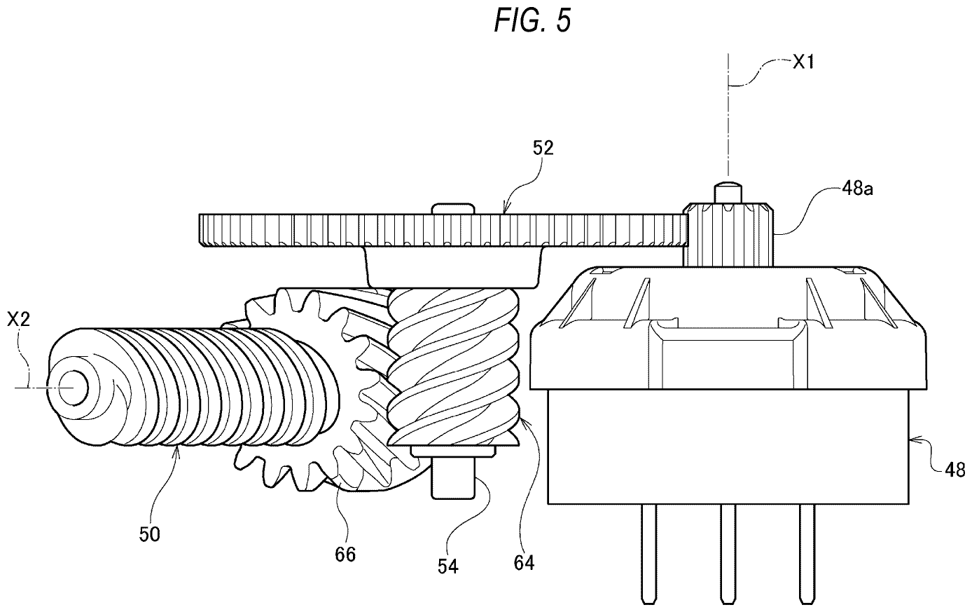

Next, a configuration of the actuator 42 according to the present embodiment will be described in detail. FIG. 3 is an overall perspective view of the actuator according to the present embodiment. FIG. 4 is an exploded perspective view of the actuator according to the present embodiment. FIG. 5 is a partial side view illustrating a main part of a speed reduction mechanism in the actuator according to the present embodiment.

The actuator 42 is used to change the irradiation direction of the vehicle lamp by the leveling adjustment described above. The actuator 42 includes a motor 48, a spur gear 52 that meshes with a pinion gear 48a fixed to a rotation shaft of the motor 48, a pin 54 that serves as a rotation shaft of the spur gear 52, a housing 56 in which a bearing portion 56a that supports the pin 54 is provided at a bottom portion, a cover 58 that covers one opening 56b of the housing 56, a holding member 60 that is attached to the other opening 56c of the housing 56, and a C-ring 62 that is attached to one end portion of the rod 44.

The actuator 42 further includes a control board 86 and a cover 88 that covers the other opening of the housing 56. The control board 86 is a printed circuit board, and is equipped with a connector 90 to which a cable for transmitting a control signal from an external vehicle ECU or a headlamp vehicle ECU is connected, a capacitor 92, three Hall ICs 94 for detecting a rotation position of a rotor of the motor 48, and other elements. A control IC (not shown) for controlling the positioning of the motor 48 is mounted on a back side of the control board 86 shown in FIG. 4.

The motor 48 according to the present embodiment is a brushless DC motor, which is a type of flat motor, so that the thickness of the housing 56 can be made as thin as possible. Here, the flat motor refers to a motor in which a thickness CT of a case in a rotation axis direction is relatively small compared to a diameter CD of a case accommodating main components, and is, for example, a motor that satisfies CD >CT. The spur gear 52 has a worm 64 fixed coaxially and meshes with a helical gear 66 provided on an outer periphery of a rotating member 50. The worm 64 and the helical gear 66 form a worm gear whose rotation axes are orthogonal to each other.

The rotating member 50 is configured to rotate as the motor 48 rotates, via a speed reduction mechanism including the pinion gear 48a, the spur gear 52, the worm 64, and the helical gear 66. In this way, by transmitting the rotation of the motor to the rotating member 50 via the speed reduction mechanism, even if a motor having a high rotation speed and a relatively small torque is used, the rotating member 50 can be rotated at an appropriate rotation speed after the speed reduction and a sufficient thrust can be obtained. Therefore, a small, flat brushless DC motor can be used for the actuator 42.

### Rotating Member

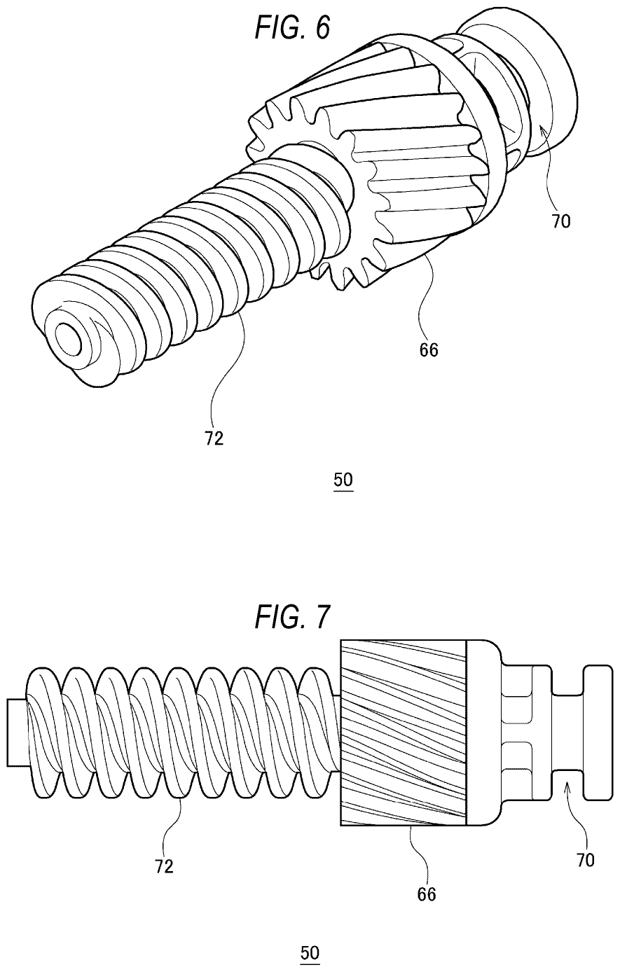

FIG. 6 is a perspective view of the rotating member according to the present embodiment. FIG. 7 is a side view of the rotating member according to the present embodiment. The rotating member 50 is a cylindrical member as a whole, and a male thread 72 is formed on an outer periphery of a rotation shaft at a front end portion connected to the rod 44. A groove 70 in which the C-ring 62 is fitted is formed on an outer periphery of a rear end portion of the rotating member 50. The helical gear 66 is formed at the center of the rotating member 50. The rotating member 50 is made of a material whose main component is nylon resin that does not contain glass fibers.

### Rod

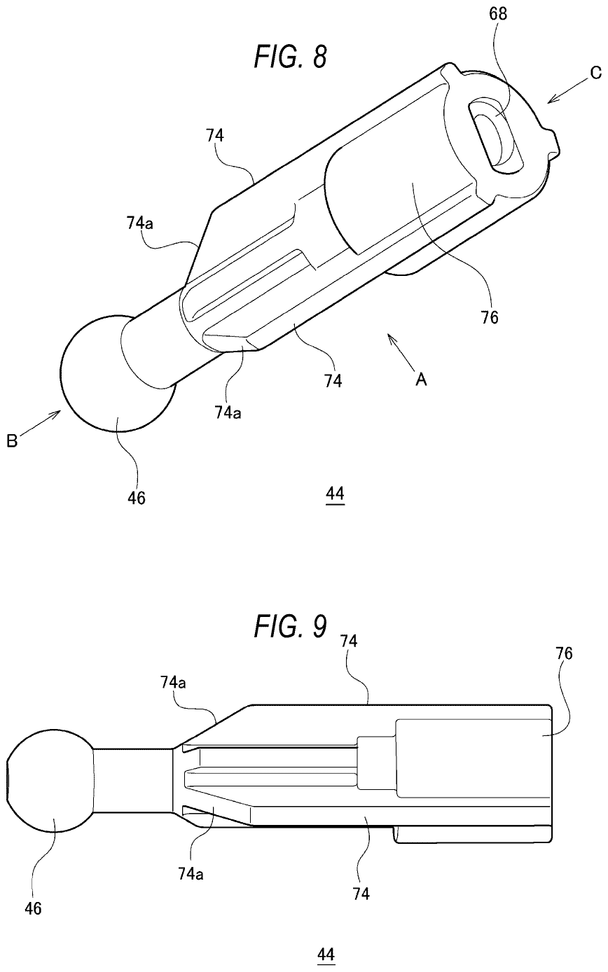

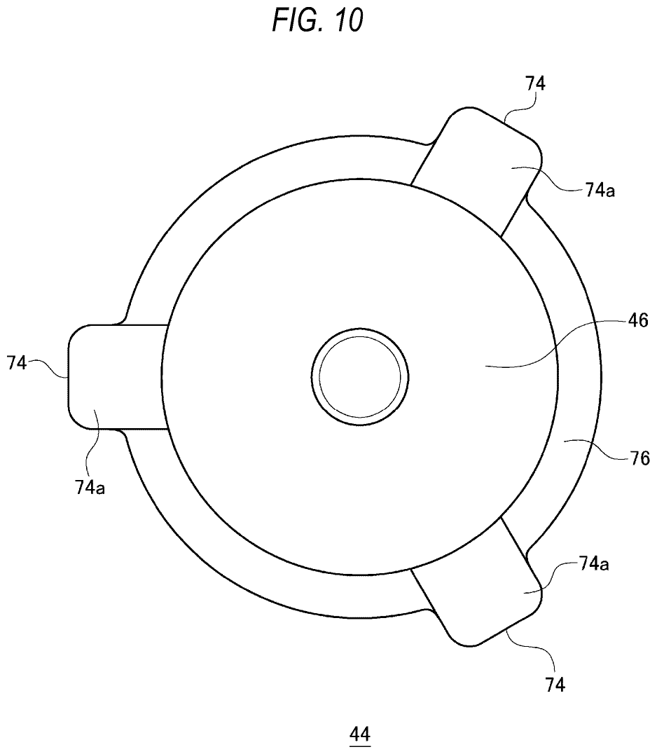

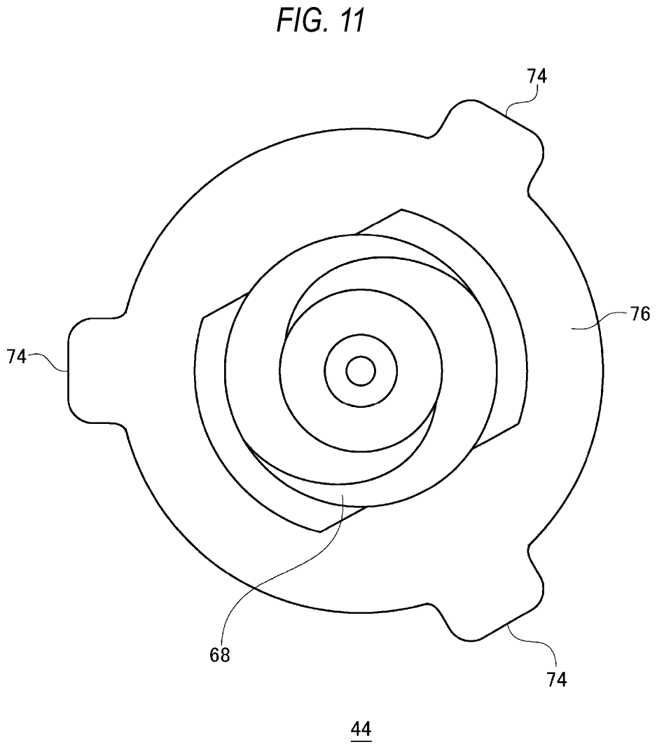

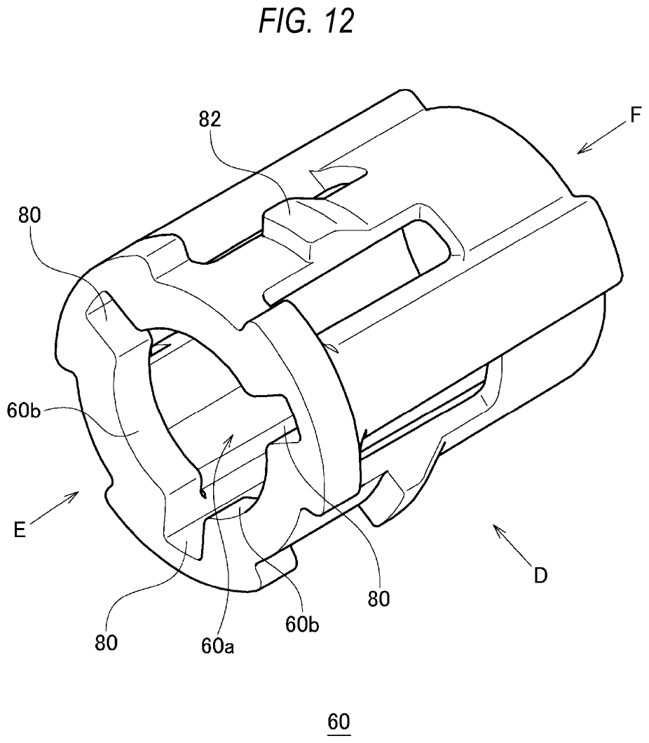

FIG. 8 is a perspective view of the rod according to the present embodiment. FIG. 9 is a view of the rod illustrated in FIG. 8 as viewed from a direction A. FIG. 10 is a view of the rod illustrated in FIG. 8 as viewed from a direction B. FIG. 11 is a view of the rod illustrated in FIG. 8 as viewed from a direction C.

The spherical portion 46 is provided at a front end portion of the rod 44. The spherical portion 46 is a connection portion connected to the bearing member 22 that forms a part of a mechanism configured to tilt an optical member (lamp unit 28) provided in the vehicle lamp 10. A female thread 68 into which the male thread 72 of the rotating member 50 is fitted (engaged) is formed in a hole along a rotation axis of a rear end portion of the rod 44. As a result, the rod 44 is coaxially coupled to the rotating member 50 in a relatively rotatable manner. Further, by forming threads on both of the rod 44 and the rotating member 50, the rotating member and the rod can be coupled to each other in a rotatable manner by simple processing.

A plurality of guide rails 74 are provided on an outer periphery of the rod 44 so as to extend in the axial direction. The rod 44 according to the present embodiment is provided with three guide rails 74 at equal intervals (120° intervals) in a circumferential direction of the rod. An inclined portion 74a is formed at a front end portion of each guide rail 74. Further, rear end portions of the guide rails 74 are coupled by an annular portion 76. Accordingly, when the rotating member 50 is coupled to the rod 44 and rotates relatively, the front end portion of the rotating member 50 moves toward the spherical portion 46 or retracts away from the spherical portion 46 while the male thread 72 and the female thread 68 are fitted to each other.

The rod 44 is made of a material different from that of the rotating member 50, and is made of a material that contains nylon resin containing glass fiber as a main component.

Instead of the nylon resin, a resin having good sliding properties, such as polyacetal resin, may be used. Accordingly, sliding friction between the rotating member 50 and the rod 44 can be reduced. The strength of the material that forms the rod 44 is greater than the strength of the material that forms the rotating member 50. This increases the strength of the rod 44 in which the female thread 68 is formed, which tends to have a thin wall thickness, and makes it easier to process and manufacture.

In the rod 44 according to the present embodiment, the female thread 68 is formed in the hole formed from the end portion on a side coupled to the rotating member 50 toward the spherical portion 46. In addition, the rotating member 50 is provided with the male thread 72 on the outer periphery of the end portion on a side coupled to the rod 44, and is coupled to the rod by the male thread 72 and the female thread 68 meshing with each other.

Since the male thread 72 is provided on the outer periphery of the rotating member 50, processing and manufacturing for forming the thread are relatively easy. The rotating member 50 is provided with the helical gear 66 having an outer diameter larger than that of the male thread 72. The rod 44 has the annular portion 76 in which a hole is formed, and the maximum diameter of the annular portion 76 is larger than the maximum diameter of the 12 helical gear 66. This allows a certain degree of thickness to be secured for the annular portion 76 of the rod 44 in which the female thread 68 is formed.

Further, in the screw speed reduction mechanism of the actuator 42 according to the present embodiment, in order to prevent damage to components due to biting into a mold, the female thread 68 is formed in the rod 44, which can secure a sufficient thickness and can be easily fixed in a rotation direction.

### Holding Member

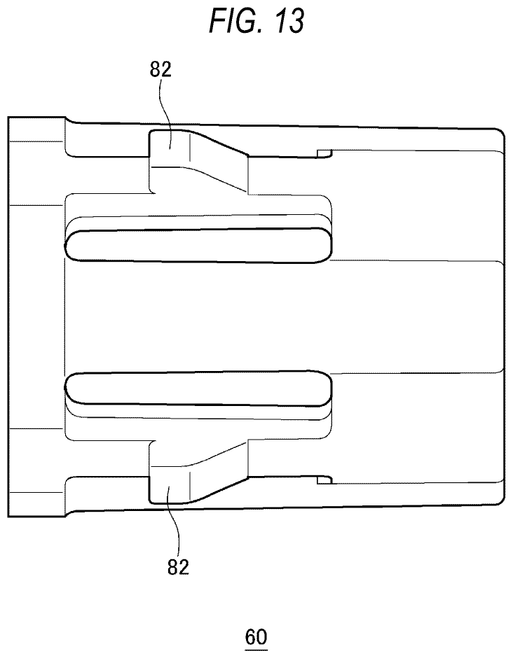

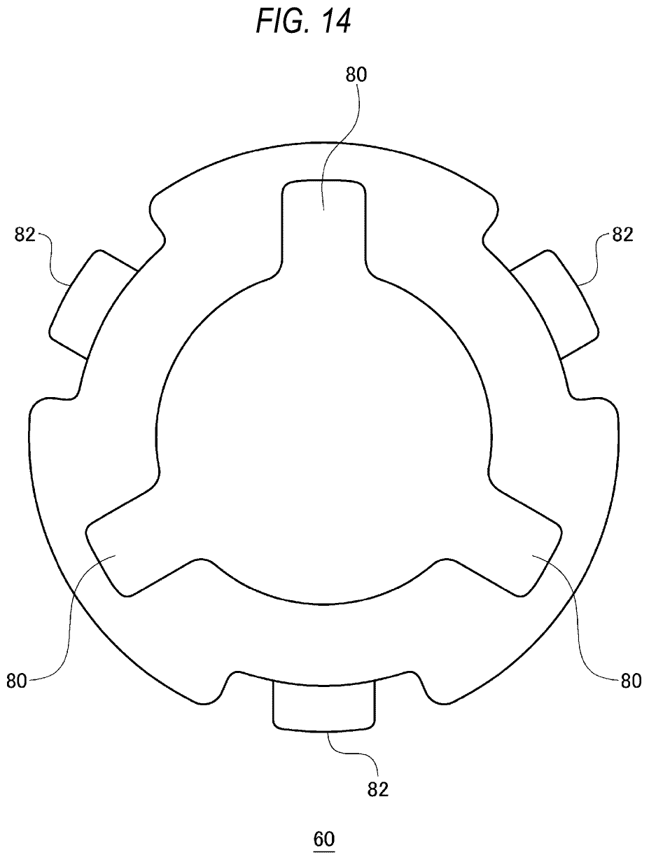

FIG. 12 is a perspective view of the holding member according to the present embodiment. FIG. 13 is a view of the rod illustrated in FIG. 12 as viewed from a direction D.

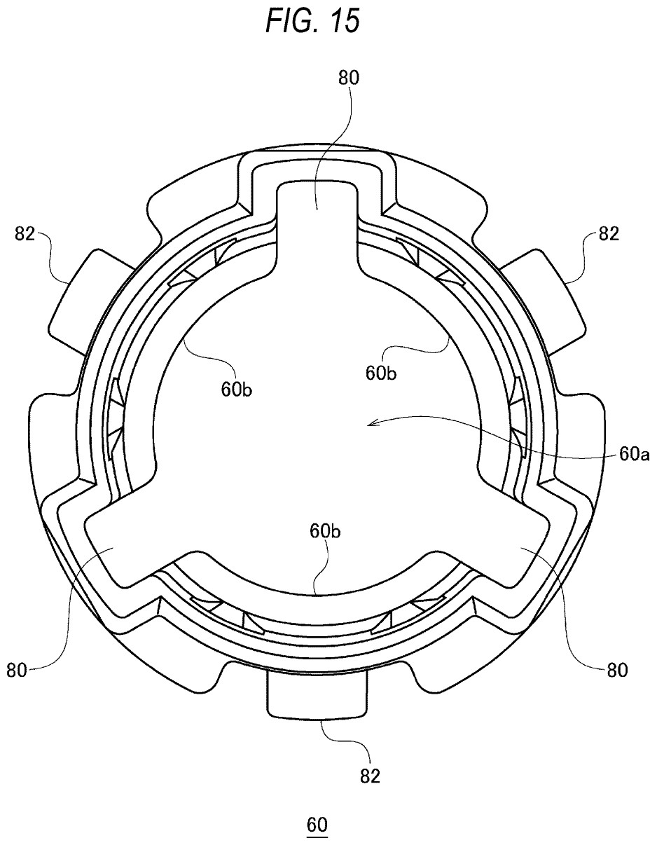

FIG. 14 is a view of the rod illustrated in FIG. 12 as viewed from a direction E. FIG. 15 is a view of the rod illustrated in FIG. 12 as viewed from a direction F.

The holding member 60 according to the present embodiment is a member that holds the rod 44 slidably in an advancing-retracting direction while preventing rattling of the rod 44 in a direction intersecting the advancing-retracting direction, and is made of a material that contains polyacetal resin as a main component. The rod 44 is attached to the opening 56c of the housing 56 that advances and retracts. A plurality of guide grooves 80 are provided in the axial direction on an inner periphery of the holding member 60. The holding member 60 according to the present embodiment is provided with three guide grooves 80 at equal intervals (120°intervals) in a circumferential direction of the holding member 60. The guide grooves 80 are configured such that the guide rails 74 of the rod 44 slides therethrough.

Accordingly, each of the plurality of guide rails 74 of the rod 44 is guided at equal intervals by each of the plurality of guide grooves 80 of the holding member 60. Accordingly, the rod 44 is less likely to tilt with respect to the holding member 60, and the rod 44 slides smoothly in the axial direction of the holding member 60 without rotating. In addition, three arc portions 60b are provided at equal intervals so as to surround an opening 60a at a front end portion of the holding member 60, and are configured to come into contact with the annular portion 76 of the rod 44.

The holding member 60 has three equally spaced protrusions 82 formed on an outer periphery thereof, and the protrusions engage with square holes 56f provided on an inner periphery of the opening 56c illustrated in FIG. 4. The protrusions 82 are provided between the guide grooves 80. Accordingly, the holding member 60 can be easily attached to the opening 56c, and the holding member 60 can hold the rod 44 without rotating or sliding in the opening 56c. Therefore, the rotation of the rod 44 is restricted by the holding member 60 when the rotating member 50 rotates. As a result, the rod 44, which is coaxial with the rotating member 50, slides in the axial direction with respect to the holding member 60 by the rotation of the rotating member 50, thereby advancing and retracting through the opening 56c. In this way, the rotating member 50 and the rod 44 according to the present embodiment can be integrated to form a compact advancing and retracting mechanism.

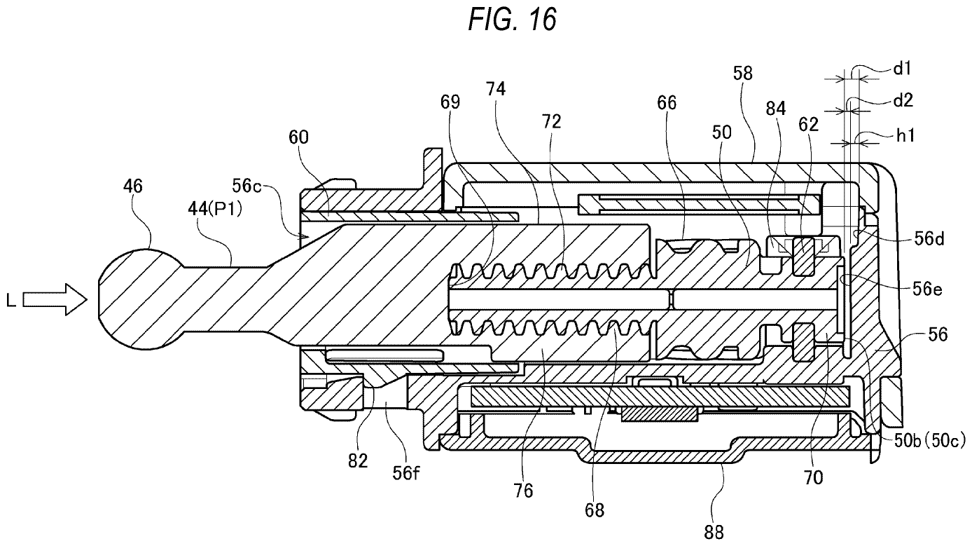

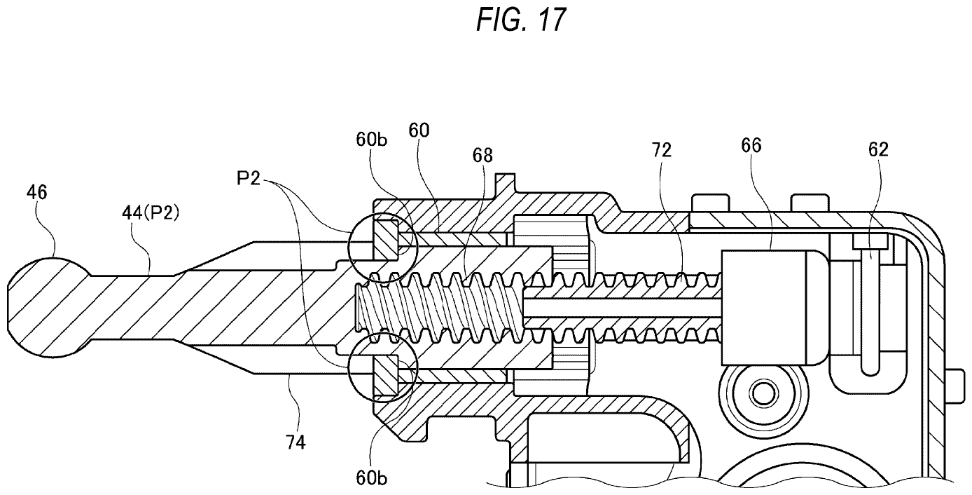

FIG. 16 is a G-G cross-sectional view of the actuator 42 illustrated in FIG. 3. FIG. 16 shows a state in which most of the rod 44 is contracted inside the housing 56. FIG. 17 is a view illustrating a state in which the rod 44 is extended further than the state illustrated in FIG. 16. The rotating member 50 is coupled to the rotating member 50 so as to be movable between a first position P1 (the state illustrated in FIG. 16) where the rotating member 50 abuts against a bottom portion 69 of a screw hole formed on the rear end side of the rod 44 at the time of contraction, and a second position P2 (the state illustrated in FIG. 17) where the rod 44 abuts against the arc portions 60b of the holding member 60 at the time of extension.

The arc portions 60b function as a positioning portion that determines a position where the rod 44 protrudes most from the opening 56c when the rod 44 abuts against the arc portions 60b. In addition, the holding member 60 has the protrusions 82 serving as an engaging portion for engagement so that the holding member 60 does not come off from the opening 56c in a state of being mounted to the opening 56c. As a result, the holding member 60 is configured such that the position at which the rod 44 protrudes most is determined, and the holding member does not come off from the opening 56c.

When the rod 44 is at the first position P1, the guide rail 74 overlaps with the female thread 68. That is, when the rod 44 is contracted, the guide rail 74 overlaps with the rotating member 50, so that the rotating member 50 and the rod 44 can be integrally shortened.

The actuator 42 according to the present embodiment described above includes the motor 48 which is a flat motor, and the housing 56 which accommodates the motor 48, the rotating member 50, and the rod 44. The rod 44 is configured such that the spherical portion 46 advances and retracts with respect to the rotating member 50 as the rotating member 50 rotates. As shown in FIG. 5, in the actuator 42, a rotation axis X1 of the motor 48 and a rotation axis X2 of the rotating member 50 are not parallel to each other. In other words, the rotation axis X1 and the rotation axis X2 are in a skew position. An angle formed between the rotation axis X1 and the rotation axis X2 according to the present embodiment is 90°.

Since the rotation axis X1 of the motor 48 and the rotation axis X2 of the rotating member 50 are in the skew position, a thickness of the motor 48 in the rotation axis direction is reduced, and a thickness of the housing 56 in a predetermined direction can be reduced.

The housing (the housing 56 and the cover 58) of the actuator 42 has a box shape as a whole, and includes the housing 56 that supports the motor 48, and the cover 58 that covers the opening 56b formed in the housing 56. As shown in FIG. 4, the opening 56b is formed such that the motor 48 is exposed when not covered by the cover 58. Accordingly, the motor 48 can be assembled to the housing 56 from the opening 56c of the housing 56.

Assuming that the height of the housing 56 shown in FIG. 3 is H, the width is W, and the thickness is D (where H>W>D), the motor 48 is disposed such that the rotation axis X1 is along the thickness direction, and the rotating member 50 is disposed along the width direction W. Accordingly, the thickness D of the motor 48 in the direction of the rotation axis X1 is reduced, and thus the thickness direction of the housing 56 can be reduced. Further, the housing 56 has the opening 56c formed on one of two surfaces in the width direction as a slide hole through which the rod 44 slides.

### Method for Controlling Actuator

Next, an example of a method for controlling the actuator will be described. An electronic control unit (hereinafter referred to as “vehicle ECU”) that performs leveling control of the vehicle controls the operation of the actuator 42 based on an output from a sensor (for example, a vehicle height sensor) provided on the vehicle side. Specifically, the vehicle ECU, upon detecting the inclination of the vehicle, calculates an inclination angle at that time based on information from the sensor, and calculates control position information of the motor 48 necessary for achieving a movement amount (advancing-retracting amount) of the rod 44 in the actuator 42 so as to obtain a desired inclination angle (horizontal state).

Then, the vehicle ECU outputs a signal corresponding to the calculated control position information to a control IC.

The signal corresponding to the control position information is input to the control IC via the connector 90. The motor 48 is electrically connected to the control board 86 and is driven by the control IC. The three Hall ICs 94 are arranged on the control board 86 at predetermined intervals along a circumferential direction of the rotor of the motor 48. When the rotor magnet rotates together with the rotor, the magnetic field in each Hall IC changes, and the on and off state of each Hall IC changes, so that a pulse signal corresponding to a rotation period of the rotor is output. The control IC counts the pulse signal to associate a count value with the rotation position of the motor 48.

### Actuator Assembly Method

Next, a method for assembling the above-described actuator will be described. As illustrated in FIG. 4, the actuator assembly method according to the present embodiment includes: a step of preparing the housing 56 in which the opening 56b and the opening 56c are provided on different side surfaces; a step of placing the rotating member 50 at a predetermined position of the housing 56 from the opening 56b; a step of inserting the rod 44 connected to the mechanism that tilts the optical member provided in the vehicle lamp from the opening 56c and coupling the rod 44 coaxially with the rotating member 50; and a step of mounting the holding member 60 for holding the rod 44 to the opening 56c. The predetermined position at which the rotating member 50 is placed is a position at which the C-ring 62 attached to the rear end portion of the rotating member 50 is held by a U-shaped protruding portion 84 provided on the bottom portion of the housing 56. The C-ring 62 is a locking portion made of a material that contains polyacetal resin as a main component.

According to this assembly method, since the rotating member 50 and the rod 44 to be coupled to each other can be inserted through different openings 56b and 56c and then coupled coaxially, the degree of freedom in the assembly process increases, and the assembly becomes easy. In addition, the overall opening may be made smaller than when components are coupled to each other in advance and then placed in the housing 56.

In addition, the assembly method according to the present embodiment includes: a step of placing the motor 48 at a predetermined position of the housing 56 from the opening 56b; and a step of placing the spur gear 52 at a predetermined position from the opening 56b, the spur gear forming the speed reduction mechanism configured to reduce the rotation of the motor 48 and transmit the reduced rotation to the rotating member 50. Accordingly, since the rotation transmission mechanism including the motor 48, the speed reduction mechanism, and the rotating member 50 can be placed through the opening 56b, the rotation transmission mechanism can be provided in the housing 56 without changing a direction of the housing 56 or changing a direction in which the member is placed. Further, by attaching the holding member 60 to the opening 56c, the movement of the rod 44 can be restricted within a predetermined range.

In the housing 56, the opening 56b is formed on one of two surfaces in the thickness direction, and the opening 56c is formed on the one of two surfaces in the width direction.

Accordingly, by placing the housing 56 with the other of the two surfaces in the thickness direction as the bottom surface, the members can be assembled from both the opening 56b and the opening 56c without rotating the housing 56.

The mounting step according to the present embodiment may be performed after the coupling step. Accordingly, by mounting the holding member 60, the rod 44 and the rotating member 50, which are coupled and integrated, do not fall off. In the mounting step, the holding member 60 may be mounted to the opening 56c from a tip end side of the rod 44.

This facilitates the mounting of the holding member 60.

### Assembly of Spherical Portion to Bearing Member

In the actuator 42 according to the present embodiment, the spherical portion 46 is finally assembled to the bearing member 22 shown in FIG. 1. At this time, as shown in FIG. 16, a large load L (several hundred N or more) is applied to the spherical portion 46 in the direction of the arrow, and a rear end portion 50b of the rotating member 50 tends to be displaced toward an inner wall 56d of the housing 56 via the rod 44.

However, the C-ring 62 is mounted in the groove 70 in the vicinity of the rear end portion 50b, and the C-ring 62 as the locking portion is fitted into the groove of the protruding portion 84, so that the rear end portion 50b is locked at a predetermined position of the housing 56. Therefore, when the rear end portion 50b tries to displace toward the inner wall 56d, a large force is applied to the C-ring 62, and if an amount of the displacement is large, the C-ring 62 may be deformed or cracked.

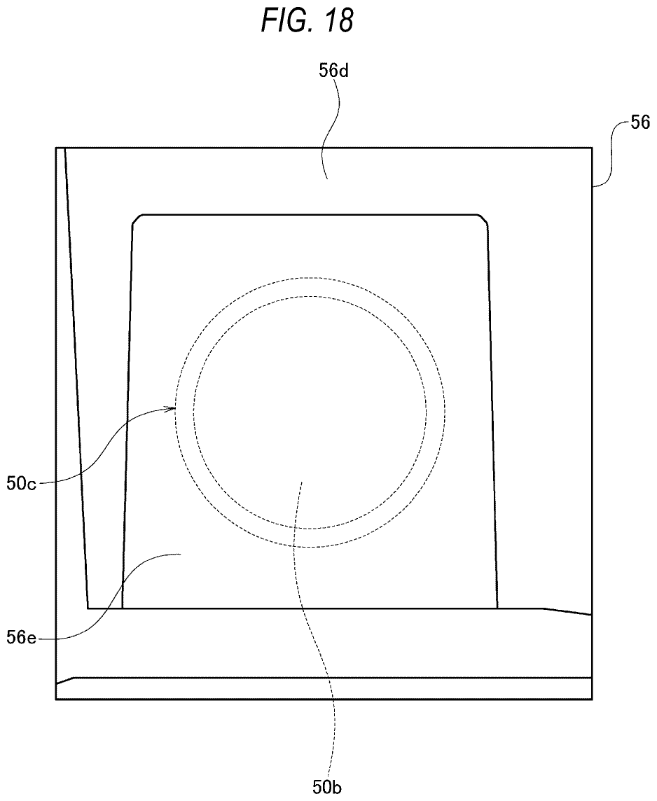

Therefore, the actuator 42 according to the present embodiment is provided with a displacement restraining portion between the rear end portion 50b of the rotating member 50 and the inner wall 56d of the housing 56 so as to restrain displacement of the rear end portion 50b. FIG. 18 is a front view of the displacement restraining portion viewed from the rear end portion of the rotating member.

The displacement restraining portion according to the present embodiment is a flat surface 56e provided on the inner wall 56d of the housing 56, against which the rear end portion 50b of the rotating member 50 abuts. The flat surface 56e is a convex portion that protrudes from the inner wall 56d. Accordingly, the flat surface 56e can be provided integrally with the housing 56 by devising the shape of the housing 56.

An area of the flat surface 56e is larger than an area of the rear end portion 50b. An end surface 50c of the rear end portion 50b has a circular shape with a recessed central portion, and the entire annular portion of an outer periphery abuts against and is in contact with the flat surface 56e. As a result, the entire end surface can abut against the flat surface 56e, and the stress of a portion where the rear end portion 50b of the rotating member 50 abuts against the flat surface 56e can be evenly distributed. The rotating member 50 may be a resin molded product manufactured using a mold. This makes it possible to easily manufacture a shape in which the central portion of the end surface is recessed.

When the convex flat surface 56e is not provided, the rear end portion 50b shown in FIG. 16 can be displaced to an interval d1 from the inner wall 56d. In this case, a large load may be applied to the C-ring 62 locked to the protruding portion 84, and this may cause deformation or cracking. However, by providing the convex flat surface 56e on the inner wall 56d, a gap between the rear end portion 50b and the flat surface 56e can be reduced to d2 (d2 <dl). As a result, the amount of displacement of the rear end portion 50b is reduced to a maximum of the gap d2, and the load applied to the C-ring 62 is reduced. That is, by reducing displacement of the rear end portion 50b of the rotating member 50, deformation and cracking of the C-ring 62 and the protruding portion 84 are limited.

The flat surface 56e according to the present embodiment is a rectangular projection extending in directions of thickness D and height H. Accordingly, displacement of the rear end portion 50b of the rotating member 50 can be reliably reduced with a simple shape.

Further, the gap d2 between the rear end portion 50 b and the flat surface 56 e may be 0.3 mm to 1.0 mm. Accordingly, the displacement of the rear end portion 50 b is limited to 0.3 mm to 1.0 mm or less. The height of the flat surface 56 e is 1.0 mm to 2.0 mm. Accordingly, the flat surface 56e that is less likely to interfere with other members in the housing 56 can be provided.

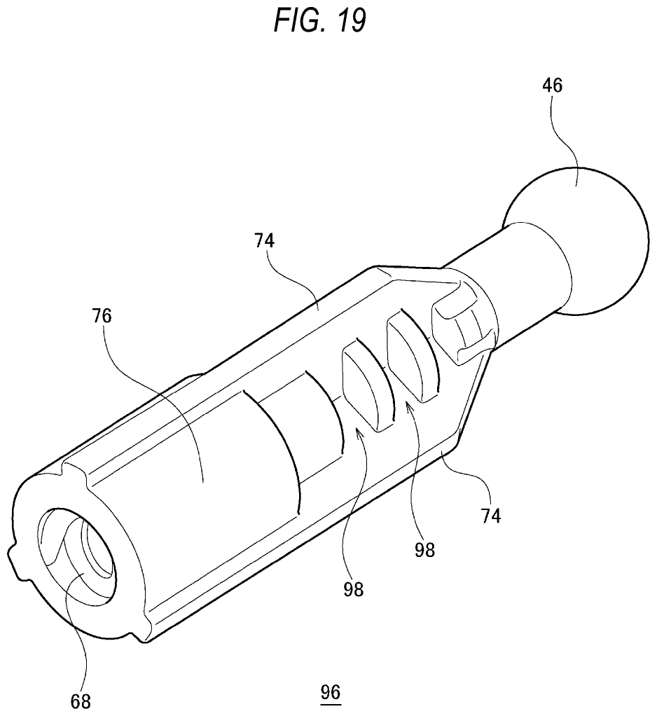

FIG. 19 is a perspective view of a rod according to a modification. The same components as those of the rod 44 described above are denoted by the same reference numerals, and the description thereof will be appropriately omitted. A rod 96 shown in FIG. 19 has hollowed-out portions 98 is formed in a region between the annular portion 76 and the spherical portion 46, at regions between the three guide rails 74 provided at equal intervals in the circumferential direction. The hollowed-out portion 98 is provided in a region where the female thread 68 is not formed at the center, and by reducing the thickness of the portion, it is possible to limit sink marks (recesses and deformation of the component surface) when the rod is manufactured in a mold.

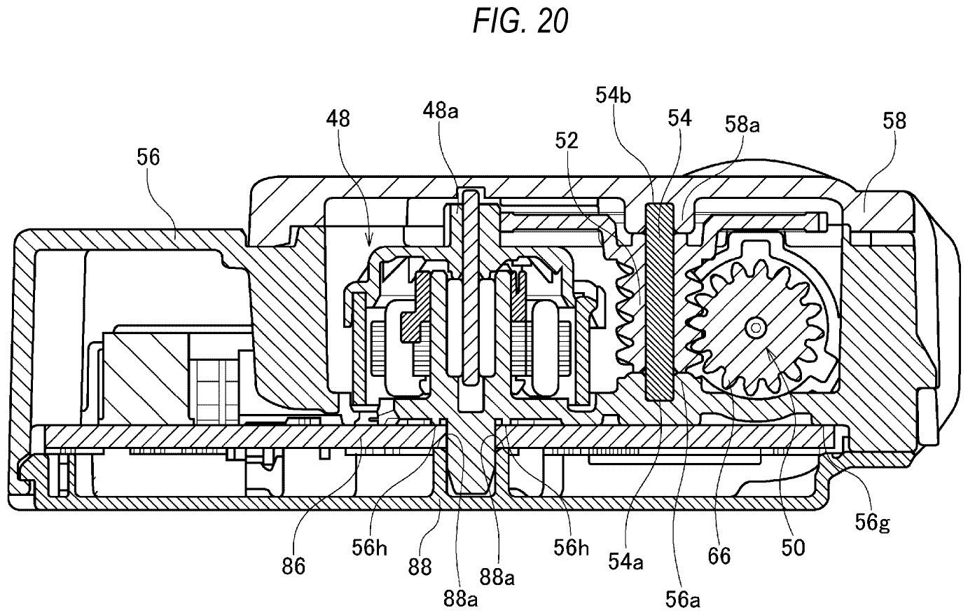

FIG. 20 is a cross-sectional view including the rotation shaft of the spur gear and the rotation shaft of the motor included in the actuator according to the present embodiment. The actuator 42 according to the present embodiment includes: the spur gear 52 serving as a reduction gear that transmits the rotation of the motor to the rotating member 50; the cover 58 serving as a housing that positions the spur gear 52 by being assembled to the housing 56; and the pin 54 serving as the rotation shaft of the spur gear 52. The housing 56 has the bearing portion 56a on which one end 54a of the pin 54 is supported. The cover 58 has a bearing portion 58a on which the other end 54b of the pin 54 is supported. The bearing portion 56a or the bearing portion 58a functions as a positioning portion that determines the position of the pin 54 in a thrust direction. Accordingly, rattling of the spur gear 52 in the thrust direction is limited in a state of being supported by the pin 54, and highly accurate positioning is enabled.

As shown in FIG. 20, the control board 86 according to the present embodiment is sandwiched between the housing 56 and the cover 88. The housing 56 includes contact portions 56g and 56h that come into contact with one surface of the control board 86. The cover 88 has a contact portion 88a that comes into contact with the other surface of the control board 86. Accordingly, the control board 86 can be sandwiched between the two housings, and rattling of the control board 86 can be limited.

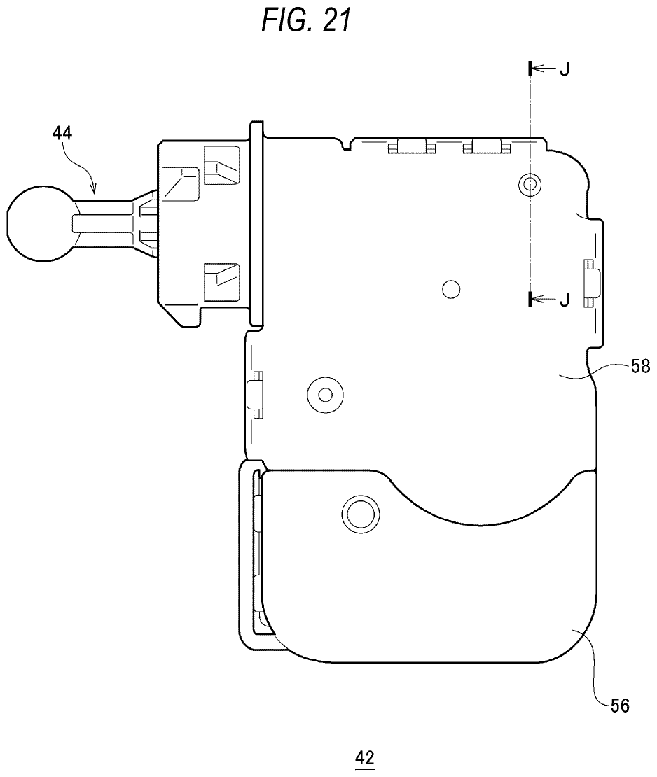

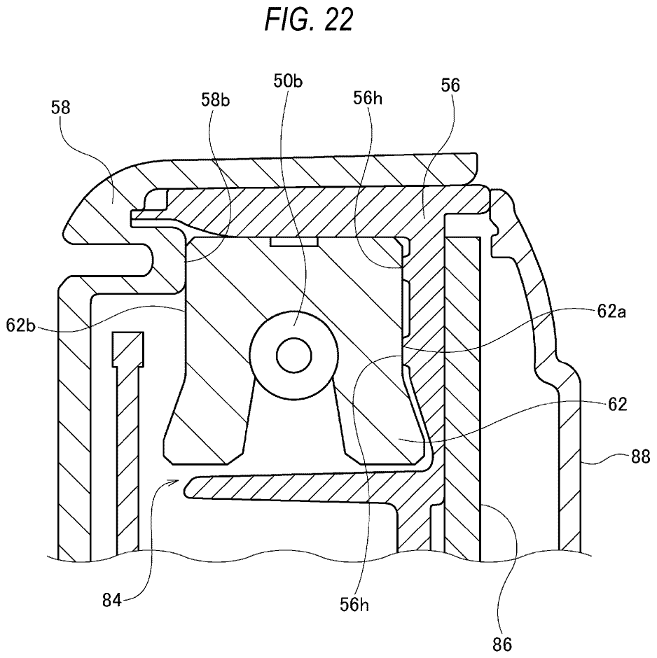

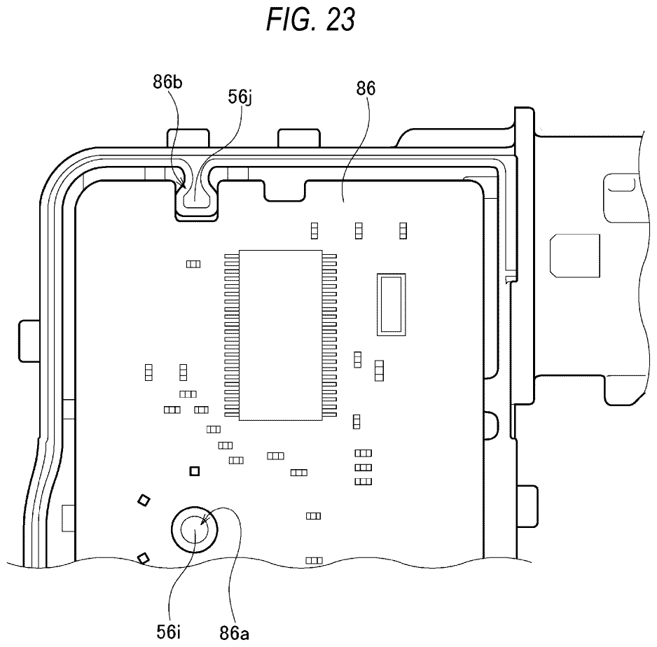

FIG. 21 is a side view illustrating an example of the actuator according to the present embodiment. FIG. 22 is a J-J cross-sectional view of the actuator illustrated in FIG.

21. The C-ring 62 is a support member that rotatably supports the rear end portion 50b of the rotating member 50. The rotating member 50 is positioned in the thrust direction of the rotating member 50 by fitting the C-ring 62 attached to the rear end portion 50b to the protruding portion 84. In addition, the C-ring 62 illustrated in FIG. 22 is positioned by assembling the cover 58 to the housing 56. The housing 56 has one or more contact portions 56h that come into contact with one side surface 62a of the C-ring 62. The cover 58 has a contact portion 58b that comes into contact with the other side surface 62b of the C-ring 62.

Accordingly, the C-ring 62 can be sandwiched by assembling the cover 58 to the housing 56, and rattling of the C-ring 62 in a radial direction can be limited. This improves the positioning accuracy of the rotating member 50 in the thrust direction and the radial direction.

FIG. 23 is a view of the control board 86 mounted on a back surface side of the housing 56 as viewed from the cover 88. Electronic components that control the rotation of the motor 48 are mounted on the control board 86. The housing 56 includes a support portion 56i that is a circular projection supporting a predetermined position of the control board 86, and a locking portion 56j that locks the control board 86 such that the control board does not rotate about the support portion 56i. The control board 86 is formed with a through hole 86a (see FIG. 4) into which the support portion 56i is fitted, and a notch 86b into which the locking portion 56j is press-fitted. The notch 86b is formed on one of the short sides of the rectangular control board 86, one the side away from the capacitor 92 and the connector 90.

The locking portion 56j is configured to be press-fitted into the notch 86b. Accordingly, the control board 86 is prevented from rotating in the housing 56 with a simple configuration, and the control board 86 can be accurately disposed at a predetermined position of the housing 56. The control board 86 is equipped with the Hall IC 94 necessary for rotation control of the motor 48, and detects the rotation position of the rotor of the motor 48. Therefore, by accurately positioning the control board 86 with respect to the housing 56 in which the portion serving as the rotation shaft of the motor 48 is formed, the detection accuracy of the Hall IC 94 is also improved.

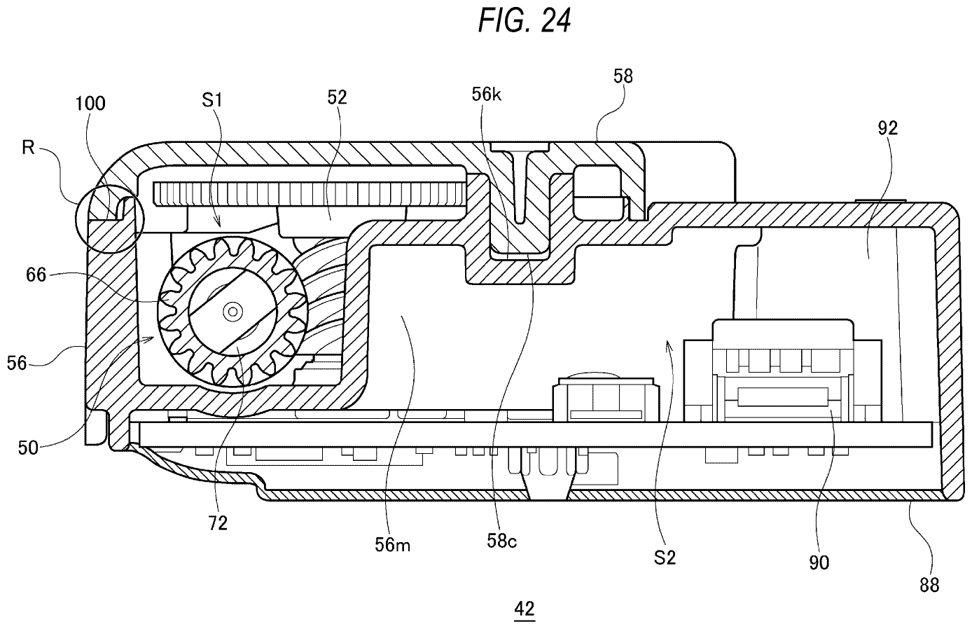

FIG. 24 is a partial cross-sectional view of the actuator according to the present embodiment as viewed from the opening side through which the rod advances and retracts. As shown in FIG. 24, the actuator 42 includes the spur gear 52 that transmits the rotation of the motor 48 to the rotating member 50, and the cover 58 that accommodates the spur gear 52 by being assembled to the housing 56. A labyrinth structure 100 is provided at a joint portion R between the housing 56 and the cover 58. Accordingly, it is possible to prevent foreign matter from entering a space surrounded by the housing 56 and the cover 58.

A projection 58c provided on the cover 58 is press-fitted into a recess 56k provided on the housing 56. Accordingly, positional deviation between the housing 56 and the cover 58 is reduced, and the cover 58 is less likely to be lifted with respect to the housing 56.

As illustrated in FIG. 24, the housing 56 of the actuator 42 includes a partition wall 56m that separates a first space S1 in which mechanical components including the rotating member 50 and the rod 44 that achieve movement of the actuator are disposed, and a second space S2 in which the capacitor 92 that is an electronic component is disposed. As a result, even if lubricating oil is used for the mechanical components disposed in the first space S1, the lubricating oil can be prevented from leaking to the second space S2.

Further, the cover 58 is assembled to one side of the housing 56 so that the rotating member 50 and the like disposed in the first space S1 are not exposed. The cover 88 is assembled to the other side of the housing 56 so that the capacitor 92 and the like disposed in the second space S2 are not exposed. Accordingly, the first space S1 and the second space S2 can be separated from each other while the mechanical components and the electronic components are accommodated in the three housings.

As illustrated in FIG. 4, the actuator 42 includes the housing 56 formed with the opening 56c through which the rod 44 advances and retracts, the control board 86, and the connector 90 that is mounted on the control board 86 and connected to a cable for transmitting a signal to an electronic component from the outside. The connector 90 is disposed in the same direction as the opening 56c. Accordingly, the rod 44 and the connector 90 can be arranged in the same direction with respect to the housing 56.

As shown in FIG. 4, the housing 56 has the opening 56n through which the cable is inserted formed on a side surface the same as a side surface on which the opening 56c is formed. Accordingly, the connection of the rod 44 and the insertion of the cable can be performed from the same direction with respect to the housing 56. In the actuator 42, the rotating member 50 and the rod 44 are disposed on the opposite side from the capacitor 92, which is an electronic component, with the motor 48 interposed therebetween. This makes it possible to reduce the size of the actuator 42. Further, the rod 44 and the rotating member 50 can be disposed at the end portion of the housing 56.

Although the present disclosure has been described with reference to the above embodiment, the present disclosure is not limited to the above embodiment, and appropriate combinations and replacements of the configurations of the embodiment are also included in the present disclosure. Based on the knowledge of those skilled in the art, it is possible to appropriately rearrange the combinations and processing orders in the embodiment, and to make various design changes and other modifications to the embodiment, and embodiments to which such modifications are added are also within the scope of the present disclosure.

This application is based on Japanese Patent Application No. 2023-077509, Japanese Patent Application No. 2023-077510, Japanese Patent Application No. 2023-077511, Japanese Patent Application No. 2023-077512, and Japanese Patent Application No. 2023-077513 filed on May 9, 2023, the contents of which are incorporated herein by reference.

1. An actuator for changing an irradiation direction of a vehicle lamp, the actuator comprising:
a rotating member configured to rotate as a motor rotates;
a rod including a connection portion connected to a mechanism configured to tilt an optical member provided in the vehicle lamp, the rod being coaxially coupled to the rotating member in a relatively rotatable manner;
a housing configured to accommodate the rotating member and the rod;
a locking portion configured to lock, at a predetermined position of the housing, a rear end portion of the rotating member, the rear side being on a opposite side to a side to which the rod is coupled; and
a displacement restraining portion provided between the rear end portion of the rotating member and the housing, the displacement restraining portion being configured to restrain displacement of the rear end portion,
wherein the displacement restraining portion is a flat surface that is provided on an inner wall of the housing and against which the rear end portion of the rotating member abuts, and
wherein the flat surface is larger in area than an end surface of the rear end portion.

2. The actuator according to claim 1, wherein the end surface has a circular shape with a recessed central portion, and an entire annular portion of an outer periphery of the end surface abuts against the flat surface.

3. (canceled)

4. The actuator according to claim 1, wherein a gap between the rear end portion and the flat surface is 0.3 mm to 1.0 mm.

5. The actuator according to claim 1,
wherein the rotating member is made of a material that contains nylon resin as a main component, and
wherein the locking portion is made of a material that contains polyacetal resin as a main component.

6.-12. (canceled)

13. An actuator for changing an irradiation direction of a vehicle lamp, the actuator comprising:
a rotating member configured to rotate as a motor rotates;
a rod including a connection portion connected to a mechanism configured to tilt an optical member provided in the vehicle lamp, and the rod being coaxially coupled to the rotating member in a relatively rotatable manner;
a housing formed with an opening through which the rod advances and retracts; and
a holding member configured to be mounted to the opening and configured to hold the rod slidably in an advancing-retracting direction while preventing rattling of the rod in a direction intersecting the advancing-retracting direction,
wherein the rod has a female thread formed in a hole formed toward the connection portion from an end portion on a side coupled to the rotating member,
wherein the rotating member has a male thread provided on an outer periphery of an end portion on a side coupled to the rod, and
wherein the male thread and the female thread mesh with each other to couple the rotating member and the rod.

14. The actuator according to claim 13,
wherein as the rotating member rotates, rotation of the rod is restricted by the holding member such that the rod slides with respect to the holding member.

15. The actuator according to claim 13,
wherein strength of a second material that forms the rod is greater than strength of a first material that forms the rotating member.

16. The actuator according to claim 15,
wherein the first material contains nylon resin as a main component, and
wherein the second material contains nylon resin that contains more glass fibers than the first material as a main component.

17. The actuator according to claim 13,
wherein the rotating member is provided with a helical gear having a larger outer diameter than the male thread.

18. The actuator according to claim 17,
wherein a maximum diameter of a cylindrical portion of the rod in which the hole is formed is larger than a maximum diameter of the helical gear.

19. The actuator according to claim 13,
wherein the rod is provided with a hollowed-out portion closer to the connection portion than the hole.

20. The actuator according to claim 13,
wherein the rod is coupled to the rotating member so as to be movable between a first position where the rod abuts against a tip end of the male thread of the rotating member at a time of contraction, and a second position where the rod abuts against a part of the holding member at a time of extension.

21. An actuator for changing an irradiation direction of a vehicle lamp, the actuator comprising:
a rotating member configured to rotate as a motor rotates;
a rod including a connection portion connected to a mechanism configured to tilt an optical member provided in the vehicle lamp, and the rod being coaxially coupled to the rotating member in a relatively rotatable manner; and
a first housing formed with an opening through which the rod advances and retracts.

22. The actuator according to claim 21, further comprising:
a reduction gear configured to transmit rotation of the motor to the rotating member;
a second housing configured to position the reduction gear by being assembled to the first housing; and
a pin serving as a rotation shaft of the reduction gear,
wherein the first housing includes a first support portion on which one end of the pin is supported,
wherein the second housing includes a second support portion on which another end of the pin is supported, and
wherein the first support portion or the second support portion includes a positioning portion configured to position the pin in a thrust direction.

23. The actuator according to claim 21, further comprising:
a board on which an electronic component configured to control rotation of the motor is mounted,
wherein the first housing includes:
a support portion configured to support a predetermined position of the board; and
a locking portion configured to lock the board such that the board does not rotate about the support portion.

24. The actuator according to claim 23, wherein the locking portion is configured to be press-fitted into a notch formed on one side of the board.

25. The actuator according to claim 23, further comprising:
a third housing configured to sandwich the board between the first housing and third housing,
wherein the first housing includes a first contact portion to come into contact with one surface of the board, and
wherein the third housing includes a second contact portion to come into contact with another surface of the board.

26. The actuator according to claim 21, further comprising:
a support member configured to rotatably support an end portion of the rotating member; and
a second housing configured to position the support member by being assembled to the first housing,
wherein the first housing includes a first contact portion to come into contact with one surface of the support member, and
wherein the second housing includes a second contact portion to come into contact with another surface of the support member.

27. The actuator according to claim 21, further comprising:
a reduction gear configured to transmit rotation of the motor to the rotating member; and
a second housing configured to accommodate the reduction gear by being assembled to the first housing,
wherein a labyrinth structure is provided at a joint portion between the first housing and the second housing.

28. The actuator according to claim 21, further comprising:
a reduction gear configured to transmit rotation of the motor to the rotating member; and
a second housing configured to accommodate the reduction gear by being assembled to the first housing,
wherein a projection provided on one of the first housing and the second housing is press-fitted into a recess provided on another of the first housing and the second housing.

29.-33. (canceled)
